(19) United States
(12) Patent Application Publication
(10) Pub. No.: US 2003/0061369 A1
(43) Pub. Date: Mar. 27, 2003

(54) Processing of multimedia data

(76) Inventors: Emre Aksu, Tampere (FI); Miska Hannuksela, Tampere (FI)

Correspondence Address: CRAWFORD PLLC, Suite 390, 1270 Northland Drive, St. Paul, MN, 55120, US

(21) Appl. No.: 10/252,017

(22) Filed: Sep. 20, 2002

(30) Foreign Application Priority Data
Sep. 24, 2001 (FI) 20011871

(51) Int. Cl. G06F 15/16

(52) U.S. Cl. 709/231; 709/203

(57) ABSTRACT

The invention relates to a method for composing a multimedia file comprising meta-data and media-data. The multimedia file is composed such that the file comprises at least one part for file level meta-data common to all media samples of the file and independent segments comprising media-data of a plurality of media samples and meta-data of said media samples.

### BACKGROUND OF THE INVENTION

The present invention relates to a method and equipment for processing of multimedia data, especially to the structures of multimedia files for streaming.

Streaming refers to the ability of an application to play synchronized media streams, such as audio and video streams, on a continuous basis while those streams are being transmitted to the client over a data network. A multimedia streaming system consists of a streaming server and a number of clients (players), which access the server via a connection medium (possibly a network connection). The clients fetch either pre-stored or live multimedia content from the server and play it back substantially in real-time while the content is being downloaded. The overall multimedia presentation may be called a movie and can be logically divided into tracks. Each track represents a timed sequence of a single media type (frames of video, for example). Within each track, each timed unit is called a media sample.

Streaming systems can be divided into two categories based on server-side technology. These categories are herein referred to as normal streaming and progressive downloading. In normal streaming, servers employ application-level means to control the bit-rate of the transmitted stream. The target is to transmit the stream at a rate that is approximately equal to its playback rate. Some servers may adjust the contents of multimedia files on the fly to meet the available network bandwidth and to avoid network congestion. Reliable or unreliable transport protocols and networks can be used. If unreliable transport protocols are in use, normal streaming servers typically encapsulate the information residing in multimedia files into network transport packets. This can be done according to specific protocols and formats, typically using the RTP/UDP (Real Time transport Protocol/User Datagram Protocol) protocols and the RTP payload formats.

Progressive downloading, which can also be referred to as HTTP (Hypertext Transfer Protocol) streaming, HTTP fast-start, or pseudo-streaming, operates on top of a reliable transport protocol. Servers may not employ any application-level means to control the bit-rate of the transmitted stream. Instead, the servers may rely on the flow control mechanisms provided by the underlying reliable transport protocol. Reliable transport protocols are typically connection-oriented. For example, TCP (Transport Control Protocol) is used to control the transmitted bit-rate with a feedback-based algorithm. Consequently, applications do not have to encapsulate any data into transport packets, but multimedia files are transmitted as such in a progressive downloading system. Thus, the clients receive exact replicas of the files residing on the server side. This enables the file to be played multiple times without needing to stream the data again.

When creating content for multimedia streaming, each media sample is compressed using a specific compression method, resulting in a bit-stream conforming to a specific format. In addition to the media compression formats there must be a container format, a file format that associates the compressed media samples with each other, among other things. In addition, the file format may include information about indexing the file, hints how to encapsulate the media into transport packets, and data how to synchronize media tracks, for example. The media bit-streams can also be referred to as the media-data, whereas all the additional information in a multimedia container file can be referred to as the meta-data. The file format is called a streaming format if it can be streamed as such on top of a data pipe from a server to a client. Consequently, streaming formats interleave media tracks to a single file, and media data appears in decoding or playback order. Streaming formats must be used when the underlying network services do not provide a separate transmission channel for each media type. Streamable file formats contain information that the streaming server can easily utilize when streaming data. For example, the format may enable storing of multiple versions of media bit-streams targeted for different network bandwidths, and the streaming server can decide which bit-rate to use according to the connection between the client and the server. Streamable formats are seldom streamed as such, and therefore they can either be interleaved or contain links to separate media tracks.

MPEG (Moving Picture Experts Group) has developed MPEG-4 which is a multimedia compression standard for arranging multimedia presentations containing moving image and voice. MPEG-4 specifications determine a set of coding tools for audio-visual objects and syntactic description of coded audio-visual objects. The file format specified for MPEG-4, called MP4, is illustrated in FIG. 1. MP4 is an object-oriented file format, where the data is encapsulated into structures called ‘atoms’. The MP4 format separates all the presentation level information (called the meta-data) from actual multimedia data samples (called the media-data), and puts it into one integral structure inside the file, which is called the ‘movie atom’. This kind of file structure can be generally referred to as ‘track-oriented’ structure, because the meta-data is separated from media-data. The media-data is referenced and interpreted by the meta-data atoms. No media-data can be interleaved with the movie atom. The MP4 file format is not a streaming format, but rather a streamable format. MP4 is not specifically designed for progressive downloading type streaming scenarios. However, it can be considered as a conventional track-oriented streaming format, if the components of the MP4 file are ordered carefully, i.e., meta-data at the beginning of a file and media-data interleaved in playback or decoding order. The proportion of meta-data varies typically between 5%-20% of the whole MP4 file size. When progressively downloading conventional track-oriented streaming files, such as MP4 files, all the meta-data must be sent before any media-data. Consequently, reception of meta-data may require buffering of long duration before the actual playback starts, which is irritating for the user. This may also mean that a client may need a large amount of memory to store the meta-data, especially if a presentation received is long. The client may not even be able to play the presentation if the meta-data does not fit into the memory. A further problem with recording is that if a recording application crashes, runs out of disk, or some other incident happens, after it has written a considerable amount of media to disk but before it writes the movie atom, the recorded data is unusable.

A typical live progressive downloading system consists of a real-time media encoder, a server, and a number of clients. The real-time media encoder encodes media tracks and encapsulates them in a streaming file, which is transmitted in real-time to the server. The server copies the file to each client. Preferably, no modifications to the file are done in the server. MP4 file format does not suit well for progressive downloading systems, and not at all for live progressive downloading systems referred to above. When an MP4 file is downloaded progressively, it is required that all meta-data precedes media-data. However, when encoding a live source, it is impossible to have meta-data related to upcoming contents of the source encoded before capturing the contents.

One approach to solve these problems is to have a ‘sample’ level interleaving of meta- and media-data, which may be referred to as sample-oriented file structure. Microsoft™'s Advanced Systems Format (ASF) is an example of such an approach. In ASF file level information is stored at the beginning of the file, as a file header section. Each media sample (i.e. the smallest access unit of media data) is encapsulated with the accompanying description of the sample. However, the ASF approach has some drawbacks: Track-based file structure is abandoned since each media sample has the accompanying meta-data encapsulated with it and there is no separate meta-data for tracks.

The distinction between meta-data and media-data is lost. As the media data is already in a packetized structure, it is difficult to extract the actual media-data and re-packetize it into another transport protocol's (e.g. RTP) payload format if necessary. This is needed when the streaming server has to stream the file to the client via a connectionless transport protocol (such as UDP) rather than sending it via progressive downloading. Interleaving the meta-data and the media-data in the sample level makes the stored file large and introduces lots of repetition of similar information. Hence, file storage redundancy can consume considerable amount of unnecessary space for long presentations.

Another approach introduced by the MPEG Group for solving these problems is called fragmented movie files. In this approach meta-data is no longer restricted to stay inside one atom, but spread into the whole file in a somewhat interleaved manner. The basic meta-data of the file is still set in the movie atom and it sets up the structure of the presentation. Besides movie atoms and media-data atoms, movie fragments are added to the file. Movie fragments extend the movie in time. They provide some of the information that has conventionally been in movie atom. The actual media samples are still stored in media data atoms.

The fragmentation of the MP4 file does not bring full independency between the fragments. Each fragment of meta-data is valid for the whole MP4 file that comes after it. Hence, the MP4 player has to store all the meta-data portions coming in fragments, even after that portion of the meta-data is used (play-and-discard approach is not possible, i.e. the fragment has to be preserved after playing it). Also, the fragments do not solve the problem related to the live streaming approach described above. This is due to the fact that the fragments are not independent of each other.

### BRIEF DESCRIPTIONS OF THE INVENTION

An object of the invention is to avoid or at least alleviate the above mentioned problems. The object of the invention is achieved with methods, a multimedia streaming system, data processing apparatuses and computer program products which are characterized by what is disclosed in the independent claims. The preferred embodiments of the invention are set forth in the dependent claims.

According to a first aspect of the invention, multimedia files are composed such that the files comprise at least one part for file-level meta-data common to all media samples of the file and independent segments comprising a plurality of media samples and meta-data of said media samples.

According to a second aspect of the invention, each independent segment is parsed in a receiving device one by one utilizing the file-level meta-data. Multimedia file refers to any grouping of data comprising both meta-data and media-data possibly from plurality of media sources. Parsing refers generally to interpreting the multimedia file especially in order to separate file-level meta-data and independent segments. The term segment refers to a timed sequence of a plurality of media samples, typically compressed by some compression method. A segment may contain one or more media types. A segment does not have to contain all media types present in the file for the particular time-period corresponding to the segment. Media samples of a certain media type within a segment should form an integral block in time. The components of the multimedia data present at a segment need not have the same durations or byte lengths.

The aspects of the invention provide advantages especially for multimedia content streaming. Less temporary storage space is required than in conventional streaming of track-oriented streaming files as there is no need to maintain already used media segments. This applies both to apparatuses composing multimedia files and to apparatuses parsing the received multimedia files. There is no need to have a meta- and media-data interleaving for each sample. The invention also provides flexibility in means of editing and retrieving information from the file. The media segments may be played independently of others, as soon as the file-level meta-data and the segment's meta-data are received, thus enabling the playback to start faster than in conventional MP4 streaming. Even one further advantage of the invention is that playback may also start from any received media segment if the file-level meta-data has been received. Compared with the ASF format, the segmented track-oriented grouping of media samples according to the invention provides a further advantage that it is more efficient and easier to re-packetize the media-data into another transport protocols's payload format when e.g. streaming the metadata by UDP instead of TCP. The present invention provides advantages also for non-streaming applications. For instance, when a multimedia file being live-recorded is uploaded, a segment may be uploaded immediately after the necessary media-data is captured and encoded.

In an embodiment of the invention, the multimedia file is downloaded progressively from a streaming server to a streaming client utilizing a reliable transport protocol such as TCP (Transport Control Protocol). According to a further embodiment, file-level meta-data can be repeated within a multimedia file in order to let new clients join a live progressive downloading session. After reception of file-level meta-data part, new clients can start parsing, decoding, and playing the multimedia file being received. Conventionally, this has not been possible. Instead, the file-level meta-data has been transmitted as a separate file to clients, for example. Such conventional methods to initiate live progressive downloading have complicated client and server implementations.

### BRIEF DESCRIPTION OF THE DRAWINGS

In the following, the invention will be described in further detail by means of preferred embodiments and with reference to the accompanying drawings, in which

FIG. 1 illustrates conventional MP4 file format;

FIG. 2 is a block diagram illustrating a transmission system or multimedia content streaming;

FIG. 3 illustrates the functions of an encoder;

FIG. 4 illustrates the functions of a multimedia retrieval client;

FIGS. 5a and 5b illustrate file formats according to preferred embodiments of the invention; and

FIG. 6 is a signalling diagram illustrating progressive downloading.

### DETAILED DESCRIPTION OF THE INVENTION

A preferred embodiment of the invention is described by a modified MPEG-4 file format. The invention may, however, be implemented also in other streaming applications and formats such as the QuickTime format.

FIG. 2 illustrates a transmission system for multimedia content streaming. The system comprises an encoder EC, which may also be referred to as an editor, preparing media content data for transmission typically from a plurality of media sources MS, a streaming server SS transmitting the encoded multimedia files over a network NW and a plurality of clients C receiving the files. The content may be from a recorder recording live presentation, e.g. a videocamera, or it may be previously stored on a storage device, such as a video tape, CD, DVD, hard disk etc. The content may be e.g. video, audio, still images and it may also comprise data files. The multimedia files from the encoder EC are transmitted to the server SS. The server SS is able to serve a plurality of clients C and respond to client requests by transmitting multimedia files from a server database or immediately from the encoder EC using unicast or multicast paths. The network NW may be e.g. a mobile communications network, a local area network, a broadcasting network or multiple different networks separated by gateways.

FIG. 3 illustrates in more detail the functions during the content creation phase in the encoder unit ENC. Raw media data are captured from one or more media sources. The output of the capturing phase is usually either compressed data or slightly compressed data. For example, the output of a video grabber card could be in an uncompressed YUV 4:2:0 format or in a motion-JPEG format. Media streams are edited to produce one or more uncompressed media tracks. It is possible to edit the media tracks in various ways, for example to reduce the video frame rate. Media tracks can then be compressed. The compressed media tracks can then be multiplexed to form a single bit stream. During this phase media-data and meta-data are arranged to the selected file format. After the file is composed, it can be sent to the streaming server SS. It should be noted that multiplexing is typically essential in progressive downloading systems, but it may not be essential in normal streaming systems, as media tracks may be transported as separate streams.

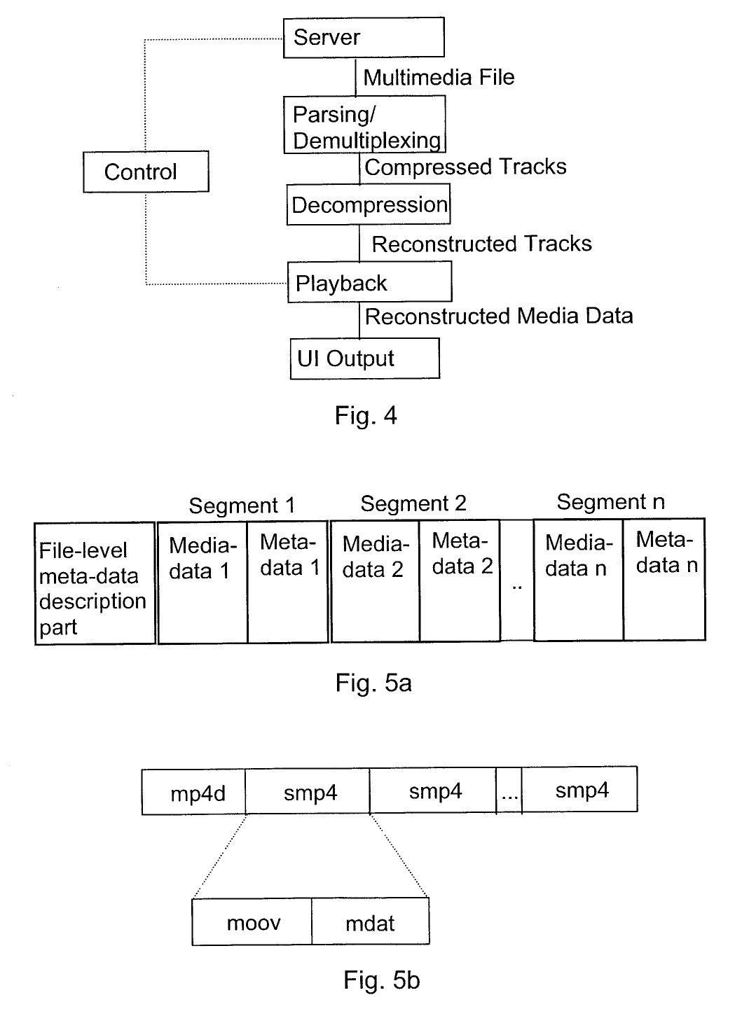

It should be noted that although in FIGS. 2 and 3 the content creation functions (by ENC) and the streaming functions (by SS) are separated, they may be done by the same device, or be carried out by more than two devices. FIG. 4 illustrates the functions of a multimedia retrieval client. The client C gets a compressed and multiplexed multimedia file from the server SS. The client C parses and demultiplexes the file in order to obtain separate media tracks. These media tracks are then decompressed to provide reconstructed media tracks which can then be played out using output devices of a user interface UI. In addition to these functions, a controller unit is provided to incorporate end user actions, i.e. to control playback according to end user input and to handle client server-control. The playback may be provided by an independent media player application or a browser plug-in.

Herein, a media sample is defined as a smallest decodable unit of compressed media data that results in an uncompressed sample or samples. For example, a compressed video frame is a media sample, and when it is decoded, an uncompressed picture is retrieved. On the contrary, a compressed video slice is not a media sample, as decoding a slice results in a spatial portion of an uncompressed sample (picture). Media samples of a single media type may be grouped into a track. Multimedia file is typically considered to comprise all media-data and meta-data related to a streamed presentation, e.g. a movie.

Meta-data carried in a multimedia file can be classified as follows. Typically the scope of a portion of meta-data is the entire file. Such meta-data may include an identification of media codecs in use or an indication of a correct display rectangle size. This kind of meta-data may be referred to as file-level meta-data (or presentation-level meta-data). Another portion of meta-data relates to specific media samples. Such meta-data may include an indication of sample type and size in bytes. Such meta-data may be referred to as sample-specific meta-data.

As media decoding and playback are typically not possible without file-level meta-data, such meta-data typically appears at the beginning of streaming files as a file header section. Sample-specific meta-data is conventionally either interleaved with media-data or it can appear as an integral section at the beginning of a file immediately after or interleaved with file-level meta-data. This causes the problems for progressive downloading or, in some file formats, progressive downloading is not possible at all.

A modified file format according to a preferred embodiment of the invention is presented in FIG. 5a. The idea is to create ‘meta-data’-‘media-data’ pairs, which can be interpreted and played back independently of the other ‘meta-data’-‘media-data’ pairs. These pairs are herein referred to as segments. The meta-data of these segments is dependent on file-level, global, meta-data description part. For progressive downloading, the file is self-contained, that is, it does not contain links to other files, and the meta-data part count restrictions are released and/or re-interpreted. Any media-specific information within segment-level meta-data, such as media-data sample offsets, is thus relative to the corresponding segment only. In other words, there is no information that is relative to other segments. Each segment is seen dependent only to itself, or the file-level meta-data part. This enables the receiving device (TE) to start playback as soon as it receives the file-level meta-data description part and a segment's meta-data and a portion of its media-data.

According to a preferred embodiment of the invention, a segment can be deleted (removed from temporary memory) after it has been parsed in the receiving device C. Less temporary storage space is thus required as only file level meta-data needs to be maintained until the last segment of the file is parsed. If the device parsing the file also plays the multimedia file, a segment may be deleted permanently after playing it. This further reduces the amount of required memory resources. The parsing/demultiplexing function first reads the file-level meta-data and separates the segments based on the file-level meta-data. After this, media tracks are separated from the data in segments one segment at a time.

FIG. 5b illustrates a modified MP4 file format according to the segmented file format principle illustrated in FIG. 5a, referred to as Progressive MP4 file. Two new atom types are defined for MP4: The MP4 description atom mp4d holds the necessary information related to the MP4 file as a whole. It should be noted that the term ‘box’ used in some MPEG-4 specifications may be used instead of atom. If any necessary information is not present in the ‘MP4 segment atom’ smp4, that information should be present in the MP4 description atom mp4d. Thus all the information inside the MP4 description atom mp4d is global, in the sense that it is valid for all the MP4 segment atoms smp4. If an atom is present in both the MP4 description atom and the movie atom moov of the MP4 segment atom smp4, then the information in the movie atom moov is taken as reference, hence overriding the MP4 description atom mp4d. The description atom mp4d may comprise any information of a conventional ‘moov’ atom of an MP4 file. This includes information e.g. on the number of media tracks and used codecs.

The MP4 segment atom smp4 encapsulates each metadata-mediadata pair present in the progressive MP4 file. The segment atom smp4 comprises a movie atom moov and a media container atom mdat. The movie atom in each smp4 encapsulates all the meta-data related to the media-data inside the media-data atom mdat of the same MP4 segment atom smp4. According to a preferred embodiment, the MP4 segment atom comprises meta-data and media-data of one or more media types. This enables preservation of track-oriented principle and easy separation of media tracks. There is no mandatory order of the segments and the file-level meta-data in a file. For practical purposes, it is advantageous to put the file-level meta-data (mp4d) at the beginning of the file, and the segment atoms smp4 in the playback order. For live streaming, fast forward or backward operations, random access, or any other purposes, the file level-level meta-data (mp4d) can be repeated within a file. Annex 1 gives a more detailed list of modified MP4 atoms.

The file format illustrated above may serve for a number of operations used in different ways, e.g. as interchange format, during content creation, in streaming or in local presentations. Progressive MP4 file is very suitable for progressive downloading operations including live content downloading. In addition, the file format enables efficient composition, editing and playback of parts of the presentation (segments), the parts being independent of preceding and forthcoming segments.

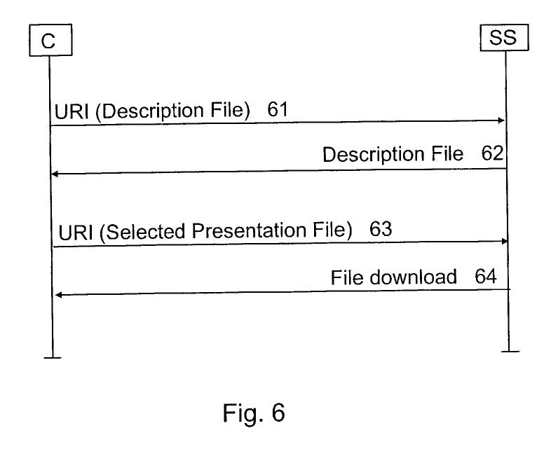

Progressive downloading example is illustrated in FIG. 6. A WWW page contains a link to a presentation description file. The file may contain descriptions of multiple versions of the same content, each of which is targeted e.g. for different bit-rates. The user of client device C selects the link and a request is delivered 61 to the server SS. If HTTP is used, ordinary GET command including the URI (Uniform Resource Identifier) of the file may be used. The file is downloaded 62, and the client C is invoked to process the received presentation description file. The most suitable presentation can be chosen. The client C requests 63 file corresponding to the chosen presentation from the web server. As a response to the request 63, the server SS starts to transfer 64 the file according to the transport protocol used.

When starting to receive a progressive MP4 file (from a streaming server SS or from local data storage medium), the client C stores the MP4 description atom mp4d. It is recommended that at least two MP4 segment atoms be read before starting playback, and during playback, a third is buffered. This enables cut-free playback. The MP4 segments should not be too large in size. Creating reasonably small sizes of MP4 segments enables playback to start faster. The need for memory in clients C is further reduced as there is no need to maintain already played segments, only the file-level meta-data part (mp4d) needs to be preserved until the last segment has been played. Playback may also start from any received segment if the file-level meta-data has been already received and only part of the file (certain tracks/MP4 segment atoms smp4) may be played.

The above described preferred embodiments of the invention may be used in any telecommunication system. The underlying transmission layer may utilize circuit-switched or packet-switched data connections. One example of such communications network is the third generation mobile communication system being developed by the 3GPP (Third Generation Partnership Project). Besides HTTP/TCP, also other transport layer protocols may be used. For instance, WTP (Wireless Transaction Protocol) of WAP (Wireless Application Protocol) suite may provide the transport functions.

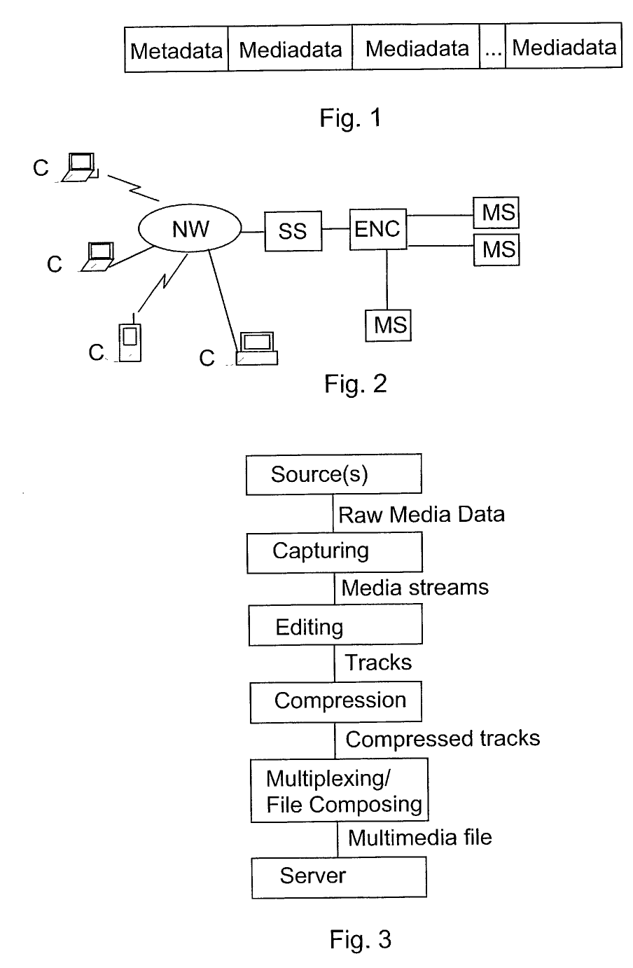

According to an embodiment, a protocol conversion may be needed in the transmission path between the server SS and the client C. In this case a gateway device may need to parse the multimedia file in order to re-packetize it according to the new transport protocol. For instance, such parsing is needed when changing from TCP's payload to UDP's payload. A file conversion may take place be from a conventional track- or sample-oriented format to the format illustrated above with reference to FIG. 5a. For example, conventional MP4 files can be converted to segmented MP4 files illustrated in FIG. 5b. Such conversion may be needed in a Multimedia Messaging Service (MMS) modified to support progressive downloading. It is likely that some MMS-capable terminals produce files according to conventional MP4 version 1 illustrated in FIG. 1, as this format is chosen in 3GPP MMS specifications. These files can be converted to segmented MP4 files in order to allow progressive downloading.

The segmented file format provides advantages also when multimedia content is created. As already described, segments are independent of each other, hence they can be created and stored immediately after the necessary media data is captured and encoded. If the device runs out of memory, it is possible to use already stored segments instead of loosing already created media samples. The segments can still be played back, unlike in the conventional MP4 creation. In live recording a segment can be uploaded immediately after the necessary media data is captured and encoded. After the encoder ENC has composed a segment and sent it to the server SS or stored it to a data storage medium, such as a memory card or a disk, it can delete it from the memory, thus reducing the required memory resources. During the file composing it is only necessary to preserve the file-level meta-data part. The uploading process can happen in real-time, i.e., the bit-rate of the transmitted file can be adjusted according to the throughput of the channel used for uploading. Alternatively, media bit-rate can be independent of the channel throughput. Real-time progressive uploading can be used as a part of a live progressive downloading system, for example. Progressive uploading is an alternative to be used in future revisions of the Multimedia Messaging Service.

According to an embodiment, it is possible to enhance systems based on conventional downloading of multimedia files in a backward-compatible manner. In other words, if files to be downloaded are constructed according to the invention, terminals not capable of progressive downloading can download the files first and play them off-line. However, other terminals can progressively download the same files. No server-side modifications are needed to support both of these alternatives. Such a feature may be desirable in the Multimedia Messaging Service. If at least a part of a multimedia message is composed according to the invention, it can be either downloaded conventionally or progressively downloaded from an appropriate element in the MMS system. As the technique modifies only the way multimedia message files are composed, no modifications to the elements in the MMS system are necessary.

The segmented file format may also simplify video editing operations. Segments may represent a logical unit in a multimedia presentation. Such a logical unit may be a news flash from a single event, for instance. If a segment is inserted to or deleted from a presentation, only a few parameter values in the file-level meta-data have to be changed, as all segment-level meta-data is relative to the segment in which they reside. In conventional track-oriented file formats, insertion or deletion of data may cause recalculation of a large number of parameter values especially if media-data is arranged in playback or decoding order.

The present invention can be implemented to the existing telecommunications devices. They all have processors and memory with which the inventive functionality described above may be implemented. A program code provides the inventive functionality when executed in a processor and may be embedded in or loaded to the device from an external storage device. Different hardware implementations are also possible, such as a circuit made of separate logic components or one or more application-specific integrated circuits (ASIC). A combination of these techniques is also possible.

It is obvious to those skilled in the art that as technology advances, the inventive concept can be implemented in many different ways. The invention is not limited to the system in FIG. 2 and may be used also in non-streaming applications. Therefore the invention and its embodiments are not limited to the above examples but may vary within the scope and spirit of the appended claims.

Annex 1.

Movie Atom (‘moov’)

There will be exactly one movie atom in each mp4 segment atom (‘smp4’), which will encapsulate all the meta-data related to the media-data inside the media data atom (‘mdat’) of the same mp4 segment atom. For the MP4 Description Atom, movie atom must contain the common meta-data, which covers the whole presentation of the progressive mp4 file. This allows efficiency in means of not sending the same information in each mp4 segment atom.

Movie Header Atom (‘mvhd’)

Movie header atom inside the MP4 Description Atom contains information which governs the whole presentation. All field syntaxes for this atom are the same. Each mp4 segment atom must have a movie header atom, which contains information related to that segment only. All field syntaxes are thus relative to the mp4 segment atom only (e.g. the duration only gives the duration of the mp4 segment atom).

Object Descriptor Atom (‘iods’)

The Object Descriptor Atom must be present in the MP4 description atom, and it may be present in the mp4 segment atoms. If it is only present in the mp4 description atom, then the information covers all the mp4 segment atoms too. If any mp4 segment atom has an object descriptor atom, then that atom overrides the one in the mp4 description atom. All field syntaxes of this atom will be the same as a normal mp4 file's object descriptor atom.

Track Atom (‘trak’)

There can be one or more track atoms inside the movie atom of an mp4 segment atom, containing the track information of the current segment atom. Presentation level track information must also be present in the mp4 description atom.

Track Header Atom (‘tkhd’)

Each mp4 segment atom and mp4 description atom must have a track header atom. For the same tracks, the track-IDs must be the same in every mp4 segment atom and the mp4 description atom. For the mp4 description atom, track header atom holds information governing the whole presentation. Track header atom of the mp4 segment atom holds information relative to the current segment atom.

Track Reference Atom (‘tref’)

The track reference atom provides a reference from the containing stream to another stream in the presentation. It is not a mandatory atom. If the track reference is valid through the whole presentation, it is advantageous to put this atom in the mp4 description atom to avoid repetition of the same information in every mp4 segment atom. All field syntaxes of this atom will be the same as a normal mp4 file's track reference atom.

Edit Atom (‘edts’)

An edit atom maps the presentation time-line to the media timeline. The edit atom is a container for the edit lists. It is not a mandatory atom. Note that the Edit atom is optional. In the absence of this atom, there is an implicit one-to-one mapping of these timelines. In the absence of an edit list, the presentation of a track starts immediately. An empty edit is used to offset the start time of a track. There can be exactly one edit atom for the whole track and it must be present in the mp4 description atom.

Edit List Atom (‘elst’)

The edit list atom contains an explicit timeline map. It is possible to represent ‘empty’ parts if the timeline, where no media is presented; a ‘dwell’, where a single time-point in the media is held for a period; and a normal mapping. Edit lists provide a mapping from the relative time (the deltas in the sample table) into absolute time (the time line of the presentation), possibly introducing ‘silent’ intervals or repeating pieces of media. Edit List Atom is not a mandatory atom. If it is present for a track, there must be exactly one edit list atom contained by the Edit Atom inside the mp4 description atom. All field syntaxes of this atom will be the same as in a edit list atom of a conventional MP4 file.

Media Atom (‘mdia’)

The media atom container contains all the objects that declare information about the media data within a stream. It must be present in the mp4 description atom and also in each mp4 segment atom.

Media Header Atom (‘mdhd’)

The media header declares the overall media-independent information relevant to the characteristics of the media in a stream. There must be exactly one media header atom per media in a track in the mp4 description atom and in each mp4 segment atom. All field syntaxes of this atom for the mp4 description atom will be the same as in a media header atom of a conventional MP4 file. For the mp4 segment atom, the duration field contains segment level duration information.

Handler Reference Atom (‘hdlr’)

The handler atom within a Media Atom declares the process by which the media-data in the stream may be presented, and thus, the nature of the media in a stream. For example, a video handler would handle a video track. Since this atom covers information concerning the whole parts of the same track media partitioned into different m4 segment atoms, it must be present only in the mp4 description atoms' media atom and assumed valid for the same track in the other mp4 segment atoms. All field syntaxes of this atom will be the same as in handler reference atom of a conventional MP4 file.

Media Information Atom (‘minf’)

The media information atom contains all the objects that declare characteristic information of the media in the stream. There must be exactly one media information atom in each track. The media information header atoms must be present only in the mp4 description atom, since they contain media-wise global information covering the whole mp4 file. Data information atom (‘dinf’) and its sub-atom data reference atom (‘dref’) must be present only in the mp4 description atom, since they contain media-wise global information covering the whole progressive mp4 file.

Sample Table Atom (‘stbl’)

Sample Table Atom must be present in every media information atom of a track in each mp4 segment atom or the mp4 description atom. The sample table contains all the time and data indexing of the media samples in a track. Using the tables here, it is possible to locate samples in time, determine their type (e.g. I-frame or not), and determine their size, container, and offset into that container.

Decoding Time To Sample Atom (‘stts’)

This atom contains a compact version of a table that allows indexing from decoding time to sample number. It is a mandatory atom for each track of the mp4 segment atom. The fields of this atom must represent the media samples in the current mp4 segment atom. Therefore, each track of the mp4 segment atom must have a decoding time to sample atom to give the sample-time information of the media samples present in that mp4 segment atom. Note that the first sample referenced by the current ‘stts’ atom is the first sample in the current mp4 segment atom. All field syntaxes of this atom will be the same as in a decoding time to sample atom of a conventional MP4 file.

Composition Time To Sample Atom (‘ctts’)

This atom provides the offset between decoding time and composition time. It is not a mandatory atom. If it is present in the track atom of the first mp4 segment atom, then it must be present in all the other tracks with the same track-ID in other mp4 segment atoms. The fields of this atom must represent the media samples in the current mp4 segment atom. All field syntaxes of this atom will be the same as in a composition time to sample atom of a conventional MP4 file.

Sync Sample Atom (‘stss’)

The sync sample atom provides a compact marking of the random access points within the stream. It is not a mandatory atom. If it is present in the track atom of the first mp4 segment atom, then it must be present in all the other tracks with the same track-ID in other mp4 segment atoms. The fields of this atom must represent the media samples in the current mp4 segment atom. Therefore each sync sample defined by the sample-number parameter must be-indexed referencing the first sample (with sample-number=1) of the media data inside the current mp4 segment atom. As an example, if a sync sample is the 25^{th} sample from the beginning of the mp4 file, but the 4th sample of an mp4 segment atom, then the sync sample atom of the mp4 segment atom holding this sample must have an index of 4 to represent this sample.

Sample Description Atoms

The sample description atoms give detailed information about the coding type used, and any initialization information needed for that coding. There must be exactly one sample description atom in the track atom of the mp4 description atom, which will provide information covering the tracks with the same track-ID in the following mp4 segment atoms. All field syntaxes of this atom will be the same as in media header atom of a conventional MP4 file.

Sample Size Atom (‘stsz’)

The sample size atom contains the sample count and a table giving the size of each sample in the media data of the current mp4 segment atom referenced by the current track. It is a mandatory atom to be present in each mp4 segment atom for the same track referenced by the same track-ID. The information inside this atom must only represent the media samples present in the current mp4 segment atom. So, the first entry in this atom represents the size of the first media sample in the current mp4 segment's media data. All other field syntaxes of this atom will be the same as in sample size atom of a conventional MP4 file.

Sample To Chunk Atom (‘stsc’)

Samples within the media data are grouped into chunks. Chunks may be of different sizes, and the samples within a chunk may have different sizes. By using this atom, the chunk that contains a sample, its position, and the associated sample description can be found. It is a mandatory atom to be present in each mp4 segment atom for the same track referenced by the same track-ID. The information inside this atom must only represent the media samples and chunks present in the current mp4 segment atom. So, the first-chunk field always has an index with respect to the first chunk (with index=1) in the current mp4 segment atom. All other field syntaxes of this atom will be the same as in sample to chunk atom of a conventional MP4 file.

Chunk Offset Atom (‘stco’)

The chunk-offset table gives the index of each chunk into the containing progressive mp4 file. All the index values are relative addresses starting from the beginning of the mp4 segment atom (mp4 segment atom base address taken as 0). It is a mandatory atom to be present in each mp4 segment atom for the same track referenced by the same track-ID. The information inside this atom must only represent the media samples and chunks present in the current mp4 segment atom. All field syntaxes of this atom will be the same as a normal mp4 file's chunk offset atom except the chunk offset now takes the beginning of the mp4 segment atom as the base offset.

Shadow Sync Sample Atom (‘stsh’)

The shadow sync table provides an optional set of sync samples that can be used when seeking or for similar purposes. In normal forward play they are ignored. This atom is not mandatory. It may not be present in every mp4 segment atom. All the sample indexes present in fields shadow-sample-number and sync-sample-number are referenced to the first media sample of the track present in the container mp4 segment atom. All other field syntaxes of this atom will be the same as in a conventional mp4 file's shadow sync sample atom.

Free space Atom (‘free’ or ‘skip’)

The contents of a free-space atom are irrelevant and may be ignored. It is not mandatory and may be present at any place in the progressive mp4 file. All field syntaxes of this atom will be the same as in a conventional mp4 file's free space atom.

1. A method for composing a multimedia file, the multimedia file comprising meta-data and media-data, the method comprising:
composing the multimedia file such that the file comprises at least one part for file-level meta-data common to all media samples of the file and independent segments comprising media-data of a plurality of media samples and meta-data of said media samples.

2. A method according to claim 1, wherein the multimedia file is downloaded progressively from a streaming server to a streaming client utilizing a reliable transport protocol such as TCP (Transport Control Protocol), and
the client decompresses the tracks after parsing and demultiplexing and plays the uncompressed tracks.

3. A method for parsing a multimedia file, wherein
the multimedia file comprises at least one part for file-level meta-data common to all media samples of the file and independent segments comprising media-data of a plurality of media samples and meta-data of said media samples, and wherein
each independent segment is parsed one by one utilizing said file-level meta-data.

4. A method according to claim 3, wherein
the multimedia file is downloaded progressively from a streaming server to a streaming client utilizing a reliable transport protocol such as TCP (Transport Control Protocol), and
the client decompresses the tracks after parsing and demultiplexing and plays the uncompressed tracks.

5. A multimedia streaming system, comprising a first device configured to compose multimedia files for streaming and a second device configured to receive streaming files and use said streaming files, wherein the first device is configured to compose a multimedia file such that the file comprises at least one part for file-level meta-data common to all media samples of the file and independent segments comprising media-data of a plurality of media samples and meta-data of said media samples,
the system is configured to transfer the multimedia file from the first device to the second device, and
the second device is configured to parse each independent segment one by one utilizing said file-level meta-data.

6. A system according to claim 5, wherein the first device is configured to send the multimedia file to a streaming server, and
the streaming server is configured to send the multimedia file to the second device.

7. A data processing apparatus comprising:
means for composing a multimedia file such that the file comprises at least one part for file-level meta-data common to all media samples of the file and independent segments comprising media-data of a plurality of media samples and meta-data of said media samples.

8. A data processing apparatus comprising:
means for receiving multimedia files comprising at least one part for file-level meta-data common to all media samples of the file and independent segments comprising media-data of a plurality of media samples and meta-data of said media samples, and
means for parsing each independent segment one by one utilizing said file-level meta-data.

9. A data processing apparatus of claim 8, wherein said apparatus is a client for a server providing progressive downloading of the multimedia files or a gateway apparatus.

10. A computer program product stored in a computer readable medium, said computer program product comprising computer readable code causing a computer to, when executed in said computer, perform the step of composing a multimedia file such that the file comprises at least one part for file-level meta-data common to all media samples of the file and independent segments comprising media-data of a plurality of media samples and meta-data of said media samples.

11. A computer program product stored in a computer readable medium, said computer program product comprising computer readable code causing a computer to, when performed in said computer, receive a multimedia file comprising at least one part for file-level meta-data common to all media samples of the file and independent segments comprising media-data of a plurality of media samples and meta-data of said media samples, and
parse each independent segment one by one utilizing said file-level meta-data.
